(19) United States
(12) Patent Application Publication
(10) Pub. No.: US 2025/0280093 A1
(43) Pub. Date: Sep. 4, 2025

(54) AUDIOVISUAL METADATA TO MAKE HOLOGRAM MEETINGS MORE REALISTIC

(71) Applicant: Cisco Technology, Inc., San Jose, CA (US)

(72) Inventors: Sigurd Klasson, Oslo (NO); Asbjom Therkelsen, Asker (NO)

(21) Appl. No.: 18/594,613

(22) Filed: Mar. 4, 2024

(51) Int. Cl. H04N 7/15; G03H 1/04; G06T 19/00

(52) U.S. Cl. CPC H04N 7/157; G03H 1/04; G06T 19/006; H04N 7/152

(57) ABSTRACT

The disclosed technology addresses the need in the art for an improved user experience for meetings with at least one holographic meeting participant in a meeting with at least three meeting participants. More specifically, in meetings with at least three meeting participants, there is often an inconsistency in the way a holographic meeting participant is viewed or experienced by other meeting participants. This inconsistency can be caused by inconsistent placement of the holographic meeting participant(s) within the physical meeting room and/or by inconsistent or unnatural behavior of the holographic meeting participant(s). The present technology addresses these aspects resulting in a poor user experience by locating holograms in consistent locations as viewed by multiple physically present meeting participants. Additionally, the present technology applies a consistent behavior for holograms in the physical meeting room such that the multiple physically present meeting participants perceive the hologram to be looking in the same direction.

### BACKGROUND

In today's digital age, remote communications have become increasingly prevalent in the business world. However, while video conferencing has made remote discussions feasible, it lacks the immersive and interactive nature of in-person meetings. Holographic technology presents a promising solution to this challenge by creating lifelike representations of meeting participants, enabling a more natural and engaging interaction. Conventional video conferencing systems often fail to provide an authentic experience, leading to communication barriers and reduced engagement. These systems typically display flat, two-dimensional images of participants on a screen, detaching the audience from the true sense of presence and interaction that comes with face-to-face encounters.

While some attempts have been made at providing video conferences that include one or more holographic meeting participants, these solutions often lack a user experience in meetings where there are three or more conference participants.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a physical meeting room, where a holographic meeting participant is located at a hologram-designated position in accordance with some aspects of the present technology.

FIG. 2A and FIG. 2B illustrates system arrangements in accordance with some aspects of the present technology.

FIG. 3 illustrates an example physical meeting room in accordance with some aspects of the present technology.

FIG. 4 illustrates an example routine for the automatic identification of designated positions within the physical meeting room in accordance with some aspects of the present technology.

FIG. 5 illustrates an example of designated positions in the physical meeting room in accordance with some aspects of the present technology.

FIG. 6 illustrates an example routine for assigning the at least three meeting participants to designated positions within the physical meeting room in accordance with some aspects of the present technology.

FIG. 7 illustrates an example routine for locating the holographic meeting participant in an available position in accordance with some aspects of the present technology.

FIG. 8 illustrates an example of a physical meeting room wherein a designated position is added to a physical meeting room map because it can accommodate a hologram in accordance with some aspects of the present technology.

FIG. 9 illustrates an example of a physical meeting room with holographic meeting participants, who can take consistent viewing angles towards the physically present meeting participants in accordance with some aspects of the present technology.

FIG. 10 illustrates an example routine for controlling the behavior of a hologram of a holographic meeting participant to face others of the at least three meeting participants in accordance with some aspects of the present technology.

FIG. 11 illustrates an example routine for controlling a rotation of a hologram of a holographic meeting participant to face an active speaker in accordance with some aspects of the present technology.

FIG. 12 illustrates the offset angle in accordance with some aspects of the present technology.

FIG. 13 shows an example of a system for implementing certain aspects of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

In one aspect, a method includes hosting, by a conference endpoint, a conference among at least three meeting participants that includes a first physically present meeting participant and a second physically present meeting participant, and holographic meeting participant that appears as a hologram in a physical meeting room, determining, by the conference endpoint, a first location of the first physically present meeting participant and a second location of the second physically present meeting participant in the physical meeting room, locating, by the conference endpoint, the holographic meeting participant in an available position that is not occupied by another of the at least three meeting participants, causing, by the conference endpoint, the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room.

The method may also include where the causing the holographic meeting participant to be rendered by the mixed reality devices of the first physically present meeting participant and the second physically present meeting participant is affected through a direct communication link between the mixed reality devices present in the physical meeting room and the conference endpoint, or through a networked connection between the mixed reality devices and a meeting service, where the conference endpoint communicates information about the physical meeting room and positions occupied by the physically present meeting participants in the physical meeting room to enable the meeting service to make decisions to locate the holographic meeting participant in an available position.

The method may also include where the determining the first location of the first physically present meeting participant and the second location of the second physically present meeting participant in the physical meeting room further includes assigning the first physically present meeting participant to a first designated position that is closest to the first location of the first physically present meeting participant, and assigning the second physically present meeting participant to a second designated position that is closest to the second location of the second physically present meeting participant and that is not occupied by the first physically present meeting participant.

The method may also include where the locating the holographic meeting participant in an available position includes identifying any unoccupied designated positions as available positions, ranking the available positions for suitability for rending of the holographic meeting participant, and assigning the holographic meeting participant to a highly ranked available position.

The method may also include determining an active speaker from among the at least three meeting participants, determining that the holographic meeting participant is not the active speaker, causing the holographic meeting participant to face the active speaker when rendered by the mixed reality devices of the first physically present meeting participant and the second physically present meeting participant.

The method may also include determining an active speaker from among the at least three meeting participants, determining that the holographic meeting participant is the active speaker, applying an active speaker behavior algorithm to control a direction of a forward vector of the holographic meeting participant, where the active speaker behavior algorithm causes the holographic meeting participant that is speaker to initially face an immediately previous active speaker and after a period begin to rotate towards other holographic meeting participants. Other technical features may be readily apparent to one skilled in the art from the following figures, descriptions, and claims.

The method may also include maintaining a map of the physical meeting room with x and y coordinates for the locations of the at least three meeting participants in the physical meeting room, rotating a forward vector of the holographic meeting participant a degree of rotation to point towards coordinates of the active speaker.

The method may also include prior to causing the holographic meeting participant to rotate to point towards the coordinates of the active speaker, calculating the degree of rotation for the forward vector of the holographic meeting participant to point towards the active speaker, determining, for the holographic meeting participant, an angle spanning from the active speaker to another non-speaking one of the at least three meeting participants, determining that the holographic meeting participant can be rendered to be viewed from the angle by the non-speaking one of the at least three meeting participants, and then causing the holographic meeting participant to be rendered at the angle of rotation, determining that the holographic meeting participant cannot be rendered at the angle of rotation, and then rotating the holographic meeting participant towards the active speaker with at a maximum angle that can be rendered.

In one aspect, a computing system includes at least one processor. The computing system also includes a memory storing instructions that, when executed by the at least one processor, configure the computing system to host a conference among at least three meeting participants that includes a first physically present meeting participant and a second physically present meeting participant, and holographic meeting participant that appears as a hologram in a physical meeting room, determine a first location of the first physically present meeting participant and a second location of the second physically present meeting participant in the physical meeting room, locate the holographic meeting participant in an available position that is not occupied by another of the at least three meeting participants, cause the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room.

In one aspect, a non-transitory computer-readable storage medium, the computer-readable storage medium including instructions that when executed by at least one processor, cause the at least one processor to host a conference among at least three meeting participants that includes a first physically present meeting participant and a second physically present meeting participant, and holographic meeting participant that appears as a hologram in a physical meeting room, determine a first location of the first physically present meeting participant and a second location of the second physically present meeting participant in the physical meeting room, locate the holographic meeting participant in an available position that is not occupied by another of the at least three meeting participants, cause the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room.

Other technical features may be readily apparent to one skilled in the art from the following figures, descriptions, and claims.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for an improved user experience for meetings with at least one holographic meeting participant in a meeting with at least three meeting participants. More specifically, in meetings with at least three meeting participants, there is often an inconsistency in the way a holographic meeting participant is viewed or experienced by other meeting participants. This inconsistency can be caused by inconsistent placement of the holographic meeting participant(s) within the physical meeting room and/or by inconsistent or unnatural behavior of the holographic meeting participant(s).

With respect to the inconsistent placement of the holographic meeting participant(s) within the physical meeting room, it can be a difficult task to place the holographic meeting participant(s) in the meeting room when there are no fixed positions for holographic meeting participant(s) in which to “snap” into. Often, in-room meeting participants choose the area in which they want to place the holographic meeting participant(s). This can result in each physically present meeting participant potentially locating the holographic meeting participant(s) in different locations within the room. This will cause a disconnect in the meeting experience, as every participant will have a different position of participants, causing confusion.

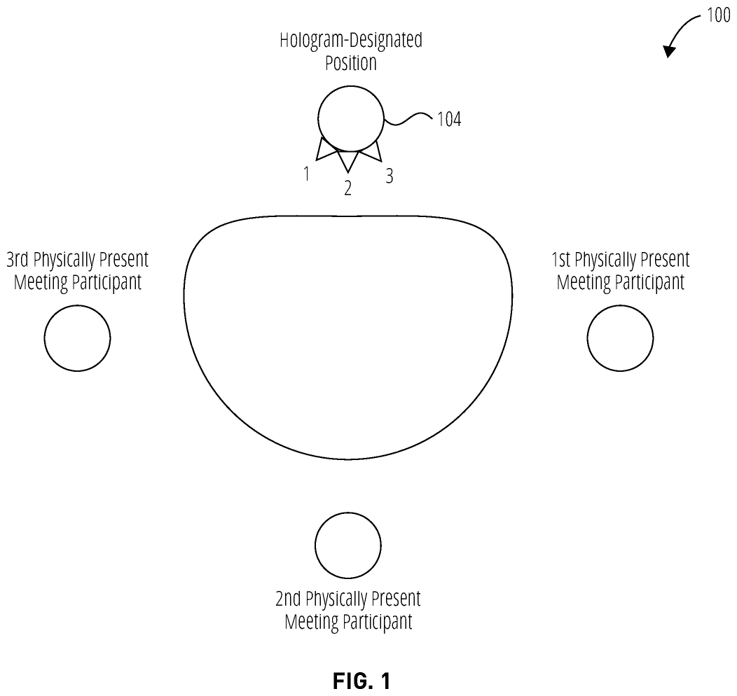

Even if the meeting participants, including the holographic meeting participant(s), are located in consistent locations holographic meeting participant(s) are often plagued by exhibiting inconsistent behavior towards other meeting participants. For example, holographic meeting participant(s) are generally rendered looking straight at the physically present meeting participant(s). As the physically present meeting participant(s) are located at different positions in the meeting, they never get the same experience on how the hologram is reacting towards the different physically present meeting participants. This scenario is illustrated in FIG. 1.

The present technology addresses these aspects resulting in a poor user experience by locating holograms in consistent locations as viewed by multiple physically present meeting participants. Additionally, the present technology applies a consistent behavior for holograms in the physical meeting room such that the multiple physically present meeting participants perceive the hologram to be looking in the same direction.

FIG. 1 illustrates a physical meeting room 100, where a holographic meeting participant is located at a hologram-designated position 104 in accordance with some aspects of the present technology. Generally, the holographic meeting participant will be rendered in “viewing position 1” when being viewed by the 3rd physically present meeting participant, but the same holographic meeting participant will be rendered in “viewing position 3” when being viewed by the 1st physically present meeting participant. This creates a disconnect in the meeting experience, as the physically present meeting participants do not experience the same meeting room dynamics as the holographic meeting participant appears to look straight at each physically present meeting participant-giving a wrong perception of attention.

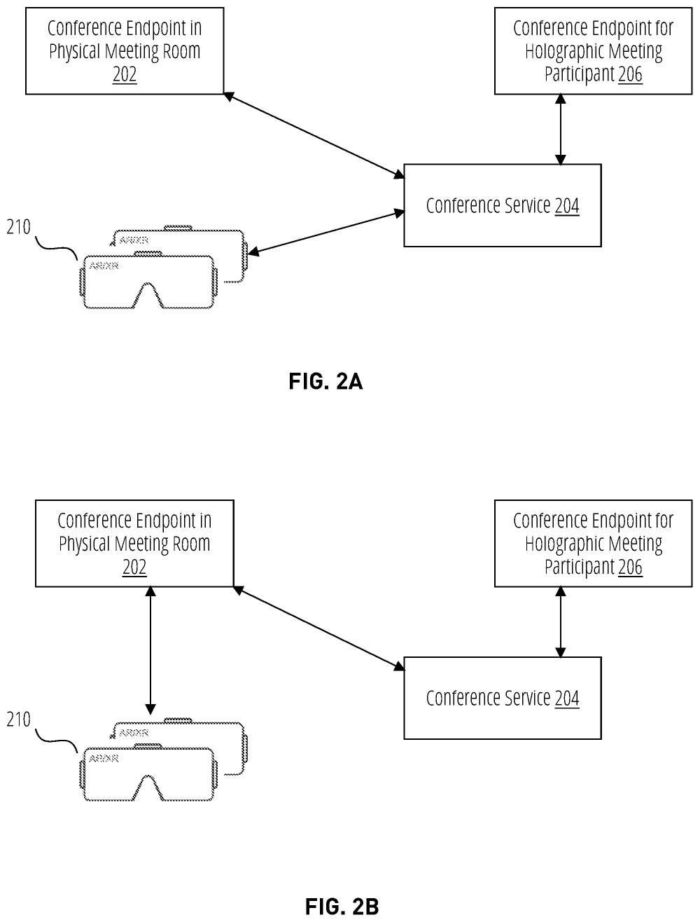

FIG. 2A and FIG. 2B illustrates conference service arrangements in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The conference service 204 provides remote communication and collaboration. The conference service 204 can provide audio and video technologies to conference participants to connect with other conference participants from any location, fostering real-time, face-to-face interactions without the need for physical proximity.

As illustrated in FIG. 2A and FIG. 2B, the conference service 204 connects a conference endpoint 202 located in a physical meeting room with conference endpoint 206 for a holographic meeting participant such that all members of the video conference can participate. While only one instance of each conference endpoint 202 and conference endpoint 206 is illustrated, multiple instances of the conference endpoints can exist if there are multiple physical meeting rooms or remote participants included in a conference hosted by the conference service 204.

Conference participants who participate within a physical meeting room, physically present meeting participants can wear a mixed reality device 210. Typically, mixed reality device 210 is a pair of augmented reality glasses or mixed reality goggles. While the physically present meeting participants can have their presence recorded by video cameras connected to the conference endpoint 202 located in a physical meeting room, the holographic meeting participants can be rendered by the mixed reality device 210 to provide the appearance that the holographic meeting participant is located in the physical meeting room.

FIG. 2A illustrates an example system arrangement where the mixed reality device 210 is in communication with the conference service 204, which provides data effective to render the holographic meeting participant to the mixed reality device 210. Such data includes data regarding the holographic meeting participant to be rendered as well as information about what to locate the hologram representing the holographic meeting participant in the physical meeting room. FIG. 2B illustrates an alternate system arrangement where the mixed reality device 210 is in communication with the conference endpoint 202, which provides data effective to render the holographic meeting participant to the mixed reality device 210.

Regardless of which device is most directly in a communication path with the mixed reality device 210, either the conference endpoint 202 in the physical meeting room or the conference service 204 can provide the some or all of the logic responsible for rendering the hologram of the holographic meeting participant. As will be addressed in greater detail herein, some information that can be used to render the hologram of the holographic meeting participant include a location in the physical meeting room where to render the holographic meeting participant, and that can be used to determine an angle from which to render the holographic meeting participant. In some instances, the conference endpoint 202 in the physical meeting room might be responsible for locating the hologram in the physical meeting room, while the conference service 204 might be responsible for behaviors of the holographic meeting participant as perceived by angles in which the hologram is rendered (e.g., to which direction a forward vector of the hologram is directed).

In other words, the causing the holographic meeting participant to be rendered by mixed reality devices of the first physically present meeting participant and the second physically present meeting participant is affected through a direct communication link between the mixed reality devices present in the physical meeting room and the conference endpoint, or through a networked connection between the mixed reality devices and a meeting service, or a combination of both.

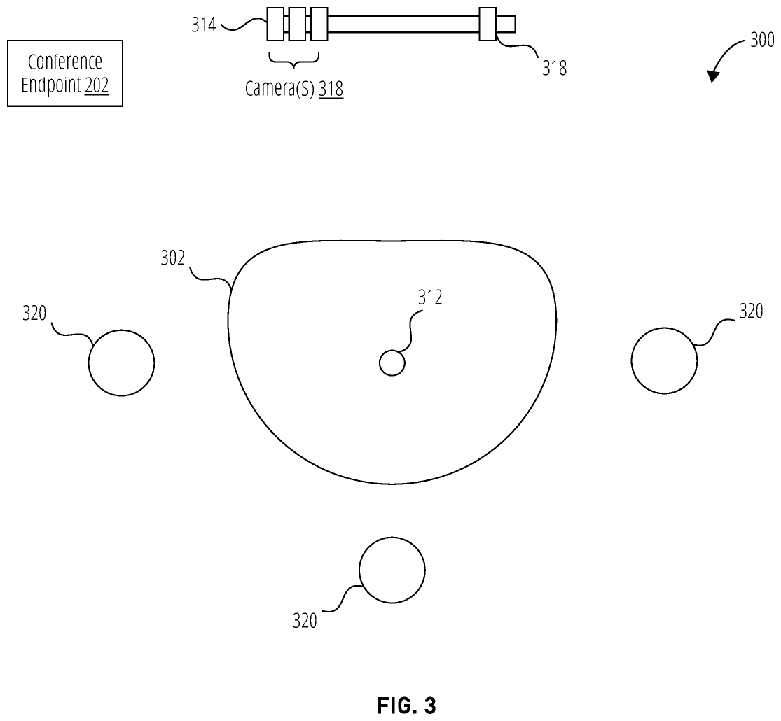

FIG. 3 illustrates an example physical meeting room 300 in accordance with some aspects of the present technology.

The physical meeting room 300 includes table 302 around which seating locations 320 are present. The physical meeting room 300 includes portions of a video conferencing system, including a conference endpoint 202 in communication with audio-visual display 314, camera(s) 318, and directional microphone(s) 312. The audio-visual display 314 can be used to display presented documents (e.g., presentations or other files) and meeting participants other than those that do not appear as holograms or physically present meeting participants in physical meeting room 300. The audio-visual display 314 can also provide sound such as speech coming from meeting participants other than the physically present meeting participants (when audio isn't provided by mixed reality device 210).

The camera(s) 318 can include any number of cameras and are responsible for capturing video of the physical meeting room 300 including the physically present meeting participants. Additionally, the camera(s) 318 can be used to identify the locations in which the physically present meeting participant(s) are sitting, and can be used in combination with directional microphone(s) 312 to aid in detecting an active speaker.

The directional microphone(s) 312 can be table-mounted or ceiling-mounted microphones for capturing audio from the physically present meeting participant(s) and for aiding in determining an active speaker within the physical meeting room 300. The directional microphone(s) 312 can determine one of the first physically present meeting participant or the second physically present meeting participant is speaking when the microphone array (located in or connected to the video collaboration device) estimates the angle and the distance seen from the camera, if this corresponds to an estimated distance and angle for a machine learning module for head detection, the first physically present meeting participant or the second physically present meeting participant is speaking.

As will be addressed in greater detail herein, an aspect of the present technology includes identifying designated positions within the physical meeting room 300. The designated positions include seating locations 320, and other locations with the physical meeting room 300 where a seat might not be present, but that a hologram of a holographic meeting participant could be rendered. The identification of the designated positions in the physical meeting room can be performed through human-aided configuration, or automatically.

When the identification of the designated position includes a human-aided setup, the conference endpoint 202 can detect an input from a human located in one of the designated positions. The input can be verbal, a gesture recognized through a machine vision technique, or a section of a physical or software button that indicates the designated position within the physical meeting room to register the human at a location within the physical meeting room.

These human-aided steps can used both to identify designated positions during a setup process and/or to identify when a human is located at the designated position during a meeting.

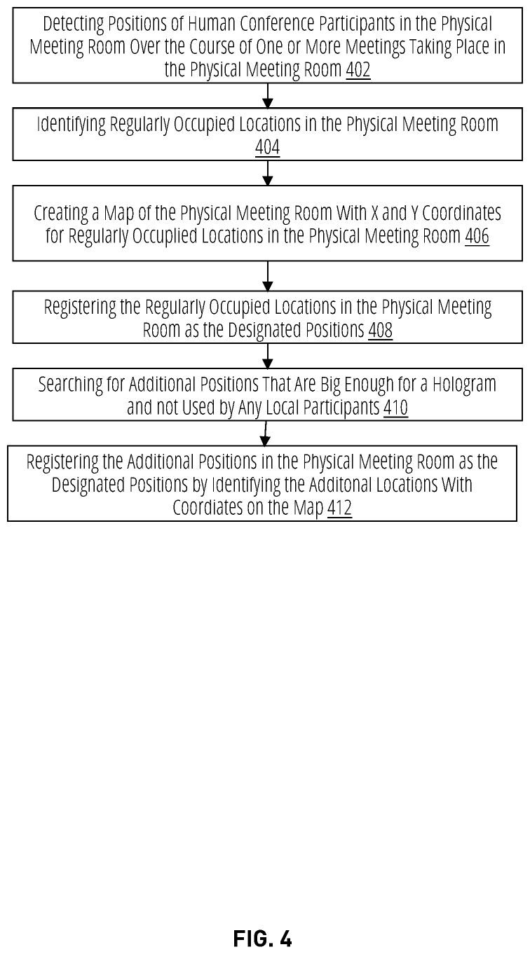

FIG. 4 illustrates an example routine for the automatic identification of designated positions within the physical meeting room 300 in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes detecting positions of human conference participants in the physical meeting room over the course of one or more meetings taking place in the physical meeting room at block 402. For example, the conference endpoint 206 illustrated in FIG. 2A may detect the positions of human conference participants in the physical meeting room over the course of one or more meetings taking place in the physical meeting room. The positions of the human conference participants in the physical meeting room are detected through the use of audio arrays, computer vision, or a combination of both.

According to some examples, the method includes identifying regularly occupied locations in the physical meeting room at block 404. For example, the conference endpoint 206 illustrated in FIG. 2A may identify regularly occupied locations in the physical meeting room.

According to some examples, the method includes creating a map of the physical meeting room with x and y coordinates for regularly occupied locations in the physical meeting room at block 406.

According to some examples, the method includes registering the regularly occupied locations in the physical meeting room as the designated positions at block 408. For example, the conference endpoint 206 illustrated in FIG. 2A may register the regularly occupied locations in the physical meeting room as the designated positions. For each meeting, the location of each participant in the meeting room is logged. After some time (and several meetings), a “heat map” will show where people usually sit. This “heat map” will be used to define the locations and the number of designated positions around the table in the meeting room.

According to some examples, the method includes searching for additional positions that are big enough for a hologram and not used by any local participants at block 410. For example, the conference endpoint 206 illustrated in FIG. 2A may search for additional positions that are big enough for a hologram and not used by any local participants.

According to some examples, the method includes registering the additional positions in the physical meeting room as the designated positions by identifying the additional locations with coordinates on the map at block 412. For example, the conference endpoint 206 illustrated in FIG. 2A may register the additional positions in the physical meeting room as the designated positions by identifying the additional locations with coordinates on the map.

These positions, like Hologram Preferred Position in Picture 1, are added to the list of “legal positions”.

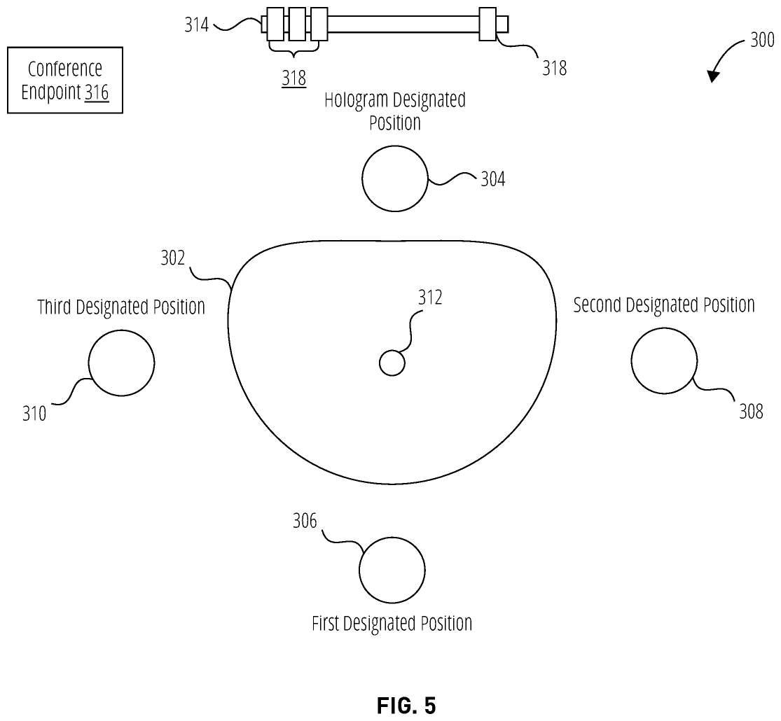

FIG. 5 illustrates an example of designated positions in the physical meeting room 300 in accordance with some aspects of the present technology.

Whether performed with manual assistance or automatically by the method of FIG. 4, the conference endpoint 316 can create and maintain a map of the physical meeting room 300 showing designated positions where meeting participants can be located. The map includes coordinates for locations of the designated positions. The first designated position 306, second designated position 308, and third designated position 310 are example positions where physically present meeting participants have been found to be located. This generally overlaps with positions having a seating device. The hologram designated position 304 represents locations where physically present meeting participants are not typically found, but the hologram designated position 304 is a space large enough to locate a hologram. Any of these designated positions are possible locations to place a hologram representing a holographic meeting participant, provided that they are available and not occupied by a physically present meeting participant.

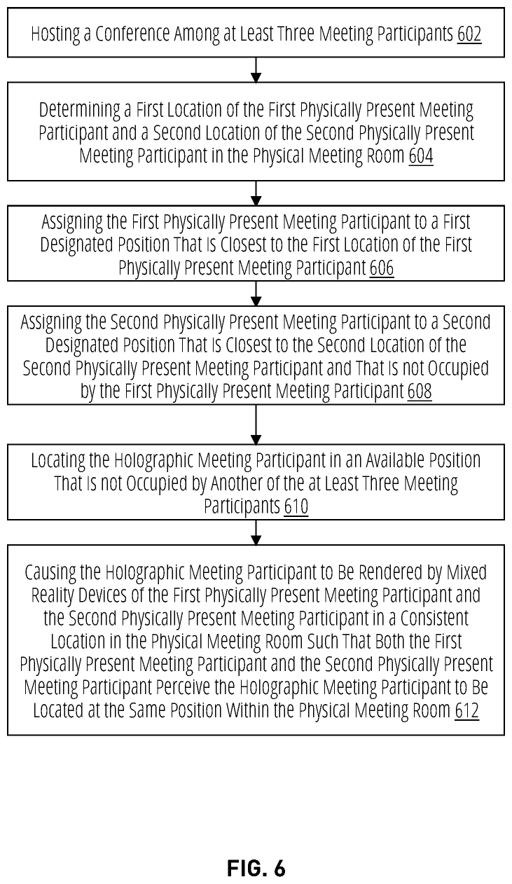

FIG. 6 illustrates an example routine for assigning the at least three meeting participants to designated positions within the physical meeting room in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes hosting a conference among at least three meeting participants at block 602. For example, the conference endpoint 202 illustrated in FIG. 2A may host a conference among at least three meeting participants. In some examples the at least three meeting participants includes any combination of holographic and physically present meeting participants as long as there is at least one holographic meeting participant and at least one physically present meeting participant. In some examples, the at least three meeting participants includes at least a first physically present meeting participant, a second physically present meeting participant, and holographic meeting participant.

A physically present meeting participant is bodily present in the physical meeting room. A holographic meeting participant is one that appears as a hologram in the physical meeting room when the hologram is presented by a mixed reality device, or other device capable of rendering or projecting a hologram.

According to some examples, the method includes determining a first location of the first physically present meeting participant and a second location of the second physically present meeting participant in the physical meeting room at block 604. For example, the conference endpoint 202 illustrated in FIG. 2A may determine locations occupied by physically present meeting participants in the physical meeting room. The locations of the physically present meeting participants can be determined using a microphone array to determine an angle and distance from a camera to a physically present meeting participant that is speaking; and/or using a camera with machine vision techniques and a directional microphone to determine the angle and distance from the camera to the physically present meeting participant that is speaking. Other techniques, such as utilizing LiDAR sensors, sonar sensors, time of flight sensors, or machine vision techniques, could also be used to identify locations of the physically present meeting participants in the physical meeting room.

According to some examples, the method includes assigning the first physically present meeting participant to a first designated position that is closest to the first location of the first physically present meeting participant at block 606. For example, the conference endpoint 202 illustrated in FIG. 2A may assign the first physically present meeting participant to a first designated position that is closest to the first location of the first physically present meeting participant.

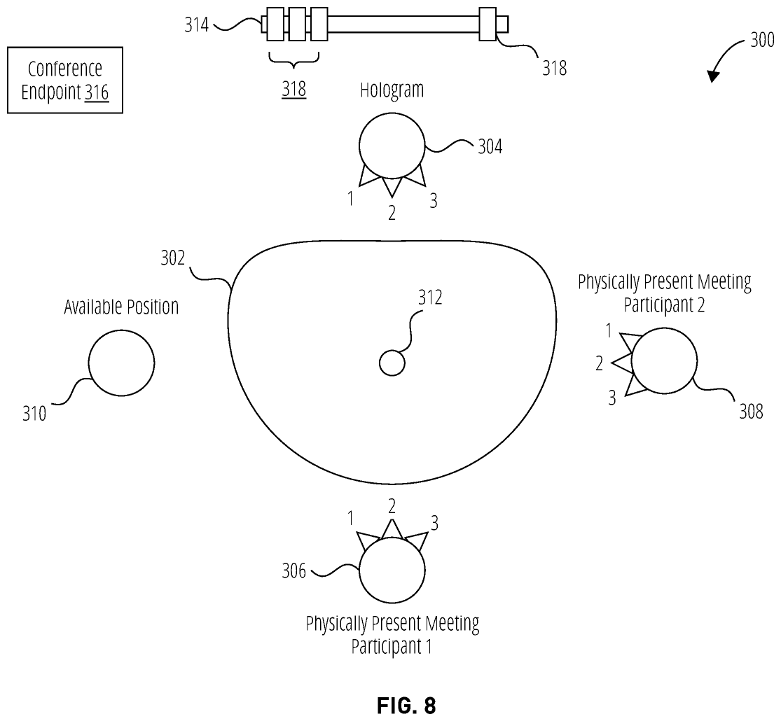

According to some examples, the method includes assigning the second physically present meeting participant to a second designated position that is closest to the second location of the second physically present meeting participant and that is not occupied by the first physically present meeting participant at block 608. For example, the conference endpoint 202 illustrated in FIG. 2A may assign the second physically present meeting participant to a second designated position that is closest to the second location of the second physically present meeting participant, and that is not occupied by the first physically present meeting participant. For example in FIG. 8, the system recognizes physically present meeting participants at the first designated position 306 and second designated position 308.

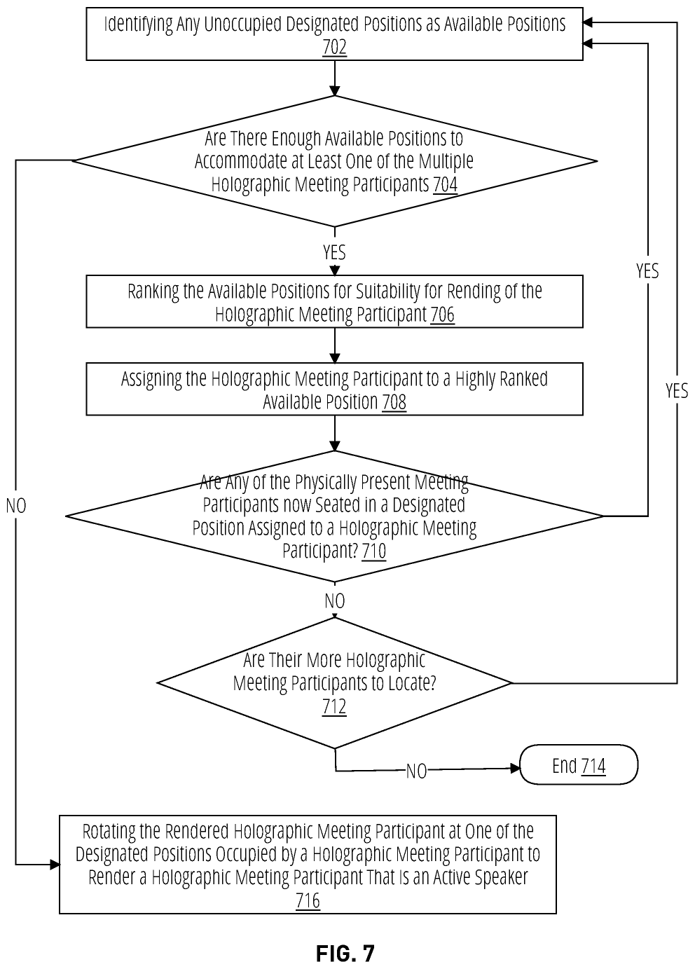

According to some examples, the method includes locating the holographic meeting participant in an available position that is not occupied by another of the at least three meeting participants at block 610. For example, the conference endpoint 202 illustrated in FIG. 2A may locate the holographic meeting participant in an available position that is not occupied by another of the at least three meeting participants. This step is addressed in more detail in FIG. 7. The at least three meeting participants are located in different available positions in the physical meeting room.

According to some examples, the method includes causing the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room at block 612. For example, the conference endpoint 202 illustrated in FIG. 2A may cause the holographic meeting participant to be rendered by mixed reality devices 210 of the first physically present meeting participant and the second physically present meeting participant in a consistent location in the physical meeting room such that both the first physically present meeting participant and the second physically present meeting participant perceive the holographic meeting participant to be located at the same position within the physical meeting room. The mixed reality devices are devices that display aspects of a physical environment such as the physical meeting room, and display virtual aspects in the physical environment, such as the holographic meeting participant located in the physical meeting room.

FIG. 7 illustrates an example routine for locating the holographic meeting participant in an available position in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

As addressed with respect to block 610, the method includes locating the holographic meeting participant in an available position that is not occupied by another of the at least three meeting participants. The method illustrated in FIG. 7 explains block 610 in greater detail.

According to some examples, the method includes identifying any unoccupied designated positions as available positions at block 702. For example, the conference endpoint 202 illustrated in FIG. 2A may identify any unoccupied designated positions as available positions. This is accomplished by determining that there are no physically present meeting participants at a designated position identified on the room map.

According to some examples, the method includes determining whether there are enough available positions to accommodate at least one of the multiple holographic meeting participants at decision block 704. For example, the conference endpoint 202 illustrated in FIG. 2A may determine whether there are enough available positions to accommodate at least one of the multiple holographic meeting participants.

According to some examples, when there are enough available positions at decision block 704, the method includes ranking the available positions for suitability for rending of the holographic meeting participant at block 706. For example, the conference endpoint 202 illustrated in FIG. 2A may rank the available positions for suitability for rending of the holographic meeting participant. Factors that affect the suitability for rendering the holographic meeting participant in one of the available positions include an amount of free space around a respective available position, and lines of sight to the respective available position from the physically present meeting participants so that the holographic meeting participant can be clearly viewed by physically present meeting participants, etc. Another factor is whether the holographic meeting participant can be rendered at angles from which the physically present meeting participants might view the holographic meeting participant. As will be addressed in greater detail herein, the holographic meeting participant can only be rendered from angles in which an image of the holographic meeting participant has been captured (or that can be supplemented by an artificial intelligence algorithm that can generate portions of a hologram that have not been captured). Accordingly, if locating the holographic meeting participant in a location might make it likely that the hologram of the holographic meeting participant would need to be viewed from an angle in which it cannot be rendered, that location should be ranked lower than positions from which the hologram can be rendered.

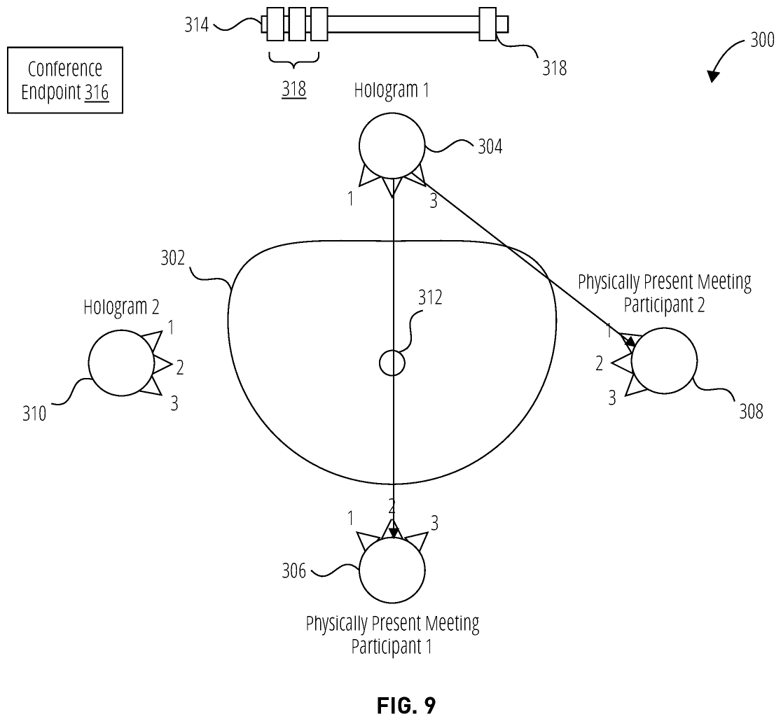

According to some examples, the method includes assigning the holographic meeting participant to a highly ranked available position at block 708. For example, the conference endpoint 202 illustrated in FIG. 2A may assign the holographic meeting participant to a highly ranked available position. This is illustrated in FIG. 9, with two holograms placed around the meeting room table. If there are 2D video participants displayed on the audio-visual display 314, the positions not obstructing the view towards the screen for local participants are ranked higher. This means that in FIG. 8, the hologram should be placed in the Vacant Position on the left side of the table, not in front of the screen.

Throughout the process of assigning holographic meeting participants to available positions in the physical meeting room, and after the process, the method watches to make sure a physically present meeting participant doesn't occupy a designated position assigned to a holographic meeting participant. For example, physically present meeting participants can come late, or more within the room. According to some examples, the method includes determining whether any of the physically present meeting participants are now seated in a designated position assigned to a holographic meeting participant at decision block 710. If there is now a conflict where a physically present meeting participant is located to the same designated position where a holographic meeting participant was assigned, the method returns to block 702 to relocate the holographic meeting participant. Conversely, if a physically present meeting participant leaves their seat, the seat is marked as an available position that is eligible to be assigned to a holographic meeting participant.

When the available positions are unchanged by movements of the physically present meeting participants, the method continues to decision block 712. According to some examples, the method includes determining whether there are more holographic meeting participants to locate at decision block 712. For example, the conference endpoint 202 illustrated in FIG. 2A determines whether there are more holographic meeting participants to locate. Multiple holographic meeting participants are assigned to highly ranked available positions in a loop until all suitable available positions are occupied by a holographic meeting participant or a physically present meeting participant by returning to block 702.

When all holographic meeting participants are assigned to an available position, the method ends at done block 714.

According to some examples, when there are not enough available positions to accommodate all of the holographic meeting participants at decision block 704, the method includes rotating the rendered holographic meeting participant at one of the designated positions occupied by a holographic meeting participant to render a holographic meeting participant that is an active speaker at block 716. For example, the conference endpoint 202 illustrated in FIG. 2A may rotate the rendered holographic meeting participant at one of the designated positions occupied by a holographic meeting participant to render a holographic meeting participant that is an active speaker. In other words, multiple holographic meeting participants can be assigned to the same designated position and the conference endpoint 202 can cause the mixed reality device to rotate which holographic meeting participant is rendered. The conference endpoint 202 can give preference to an actively speaking holographic meeting participant over others who are not actively speaking.

FIG. 8 illustrates an example physical meeting room 300 wherein a designated position is added to a physical meeting room map because it can accommodate a hologram in accordance with some aspects of the present technology.

As addressed with respect to FIG. 6, hologram designated position 304 can be a designated position even though there is no chair in that position and no physically present meeting participant typically sits there.

Although hologram designated position 304 is a valid designated position it is not an optimal designated position to place one of the holographic meeting participants unless other designated positions are already occupied because hologram designated position 304 would obscure any content displayed on audio-visual display 314.

FIG. 9 illustrates an example physical meeting room 300 demonstrating that holographic meeting participants can take consistent viewing angles towards the physically present meeting participants in accordance with some aspects of the present technology.

This is illustrated in FIG. 9, with two holograms placed around the meeting room table. If there are 2D video participants displayed on the audio-visual display 314, the positions not obstructing the view towards the screen for local participants are ranked higher. This means that in FIG. 8, the hologram should be placed in the Vacant Position on the left side of the table, not in front of the screen.

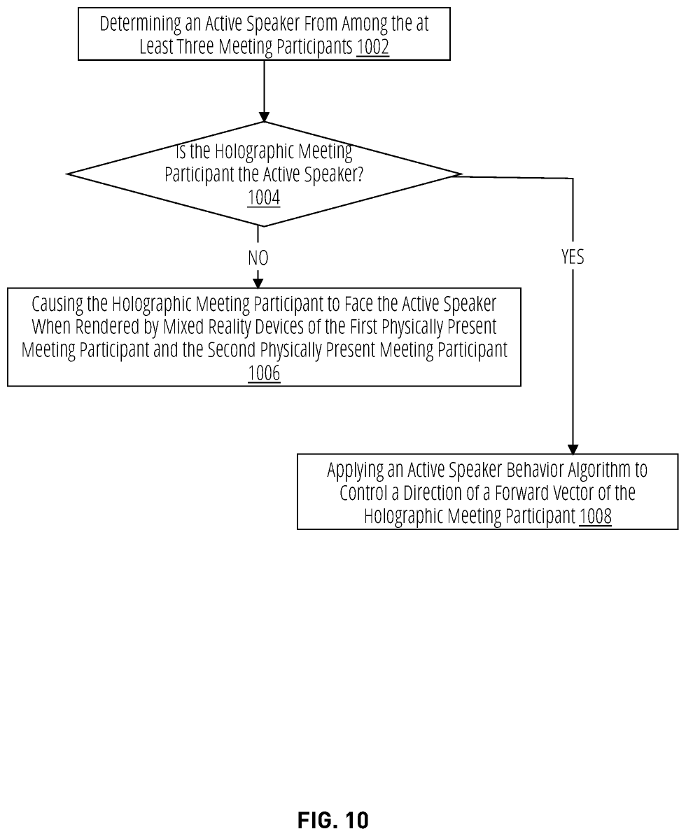

FIG. 10 illustrates an example routine for controlling the behavior of a hologram of a holographic meeting participant to face others of the at least three meeting participants in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes determining an active speaker from among the at least three meeting participants at block 1002. For example, the conference endpoint 202 illustrated in FIG. 2A may determine an active speaker from among the at least three meeting participants.

According to some examples, the method includes determining whether the holographic meeting participant is the active speaker at decision block 1004. For example, the conference endpoint 202 illustrated in FIG. 2A may determine whether the holographic meeting participant or a physically present meeting participant is the active speaker. The conference endpoint 202 can determine that the holographic meeting participant is speaking when an audio level coming from a remote site associated with the holographic meeting participant is above a threshold.

According to some examples, when the holographic meeting participant is not the active speaker, the method includes causing the holographic meeting participant to face the active speaker when rendered by mixed reality devices of the first physically present meeting participant and the second physically present meeting participant at block 1006. For example, the conference endpoint 202 illustrated in FIG. 2A may cause the holographic meeting participant to face the active speaker.

The holograms that are not speaking are rotated towards the hologram or physical participant that is speaking. For example, as illustrated in FIG. 9, if the physically present meeting participant 2 at the second designated position 308 is the active speaker, Hologram 1 at hologram designated position 304 will be rotated to position 3 to face the second designated position 308. Meanwhile, Hologram 2 at the third designated position 310 will be rotated to position 2 to face the second designated position 308. Similarly, if physically present meeting participant 1 at the first designated position 306 is marked as “speaking”, Hologram 1 at the hologram designated position 304 will be rotated to position 2, and Hologram 2 at the third designated position 310 will be rotated to position 3. When the rotation angle for a hologram changes, the movement should start slowly and ramp up, and then ramp down at the end of the rotation to animate a natural motion.

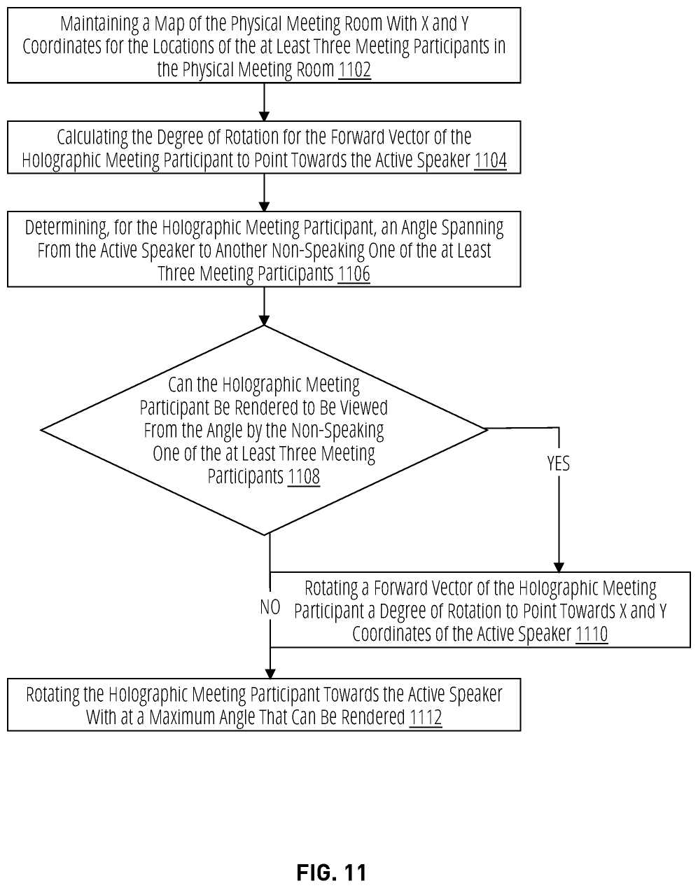

More details of the rotation of a hologram of a holographic meeting participant are addressed with respect to FIG. 11.

When the holographic meeting participant is the active speaker, according to some examples, the method includes applying an active speaker behavior algorithm to control the direction of a forward vector of the holographic meeting participant at block 1008. For example, the conference endpoint 202 illustrated in FIG. 2A may apply an active speaker behavior algorithm to control the direction of a forward vector of the holographic meeting participant. The active speaker behavior algorithm causes the holographic meeting participant, that is, the speaker, to initially face an immediately previous active speaker and, after a period, begin to rotate towards other holographic meeting participants.

In some embodiments, the active speaker behavior algorithm can also take inputs from the Translate from the conference endpoint 206 for the holographic meeting participant to track who the holographic meeting participant is looking at using gaze tracking. The conference endpoint 206 can send information about the meeting participant that the holographic meeting participant is looking at on their display and cause the conference endpoint 202 to cause the hologram of the holographic meeting participant to look at the same person.

FIG. 11 illustrates an example routine for controlling a rotation of a hologram of a holographic meeting participant to face an active speaker in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The example routine illustrated in FIG. 11 provides more detail to block 1006 addressed above.

According to some examples, the method includes maintaining a map of the physical meeting room with x and y coordinates for the locations of the at least three meeting participants in the physical meeting room at block 1102. For example, the conference endpoint 202 illustrated in FIG. 2A may maintain a map of the physical meeting room with coordinates for the locations of at least three meeting participants in the physical meeting room.

According to some examples, the method includes calculating the degree of rotation for the forward vector of the holographic meeting participant to point toward the active speaker at block 1104. For example, the conference endpoint 202 illustrated in FIG. 2A may calculate the degree of rotation for the forward vector of the holographic meeting participant to point toward the active speaker. The forward vector is a vector drawn from the hologram in the direction that the head of the hologram is turned.

According to some examples, the method includes determining, for the holographic meeting participant, an offset angle spanning from the active speaker to another non-speaking one of the at least three meeting participants at block 1106. For example, the conference endpoint 202 illustrated in FIG. 2A may determine the offset angle spanning from the active speaker to another non-speaking one of the at least three meeting participants.

The hologram of the holographic meeting participant will need to face the active speaker with a zero degree of rotation since the hologram will be directly facing the active speaker, but other non-speaking meeting participants, will view the hologram from the offset angle determined above.

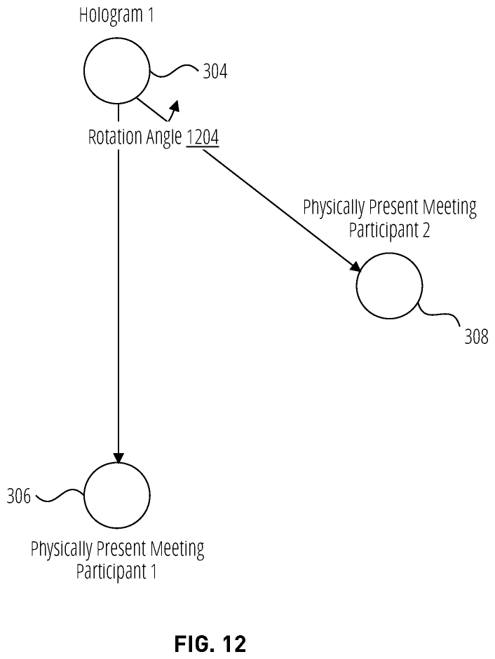

For example, FIG. 12 illustrates the offset angle in accordance with some aspects of the present technology. Hologram 1 begins by facing physically present meeting participant 1 at the first designated position 306 until physically present meeting participant 2 becomes the active speaker. Hologram 1 needs to rotate toward the second designated position 308 by a rotation angle 1204. After the rotation of Hologram 1 by the rotation angle 1204, the physically present meeting participant 2 will view the face of Hologram 1 directly, while physically present meeting participant 1 will view the face of Hologram 1 at an angle equal to the rotation angle 1204.

According to some examples, the method includes determining whether the holographic meeting participant can be rendered to be viewed from the rotation angle by the non-speaking one of the at least three meeting participants at decision block 1108. For example, the conference endpoint 202 illustrated in FIG. 2A may determine whether the holographic meeting participant can be rendered to be viewed from the rotation angle by the non-speaking one of the at least three meeting participants.

When the holographic meeting participant can be rendered to be viewed from the rotation angle, according to some examples, the method includes rotating a forward vector of the hologram of the holographic meeting participant a degree of rotation equal to the rotation angle to point towards x and y coordinates of the active speaker at block 1110. For example, the conference endpoint 202 illustrated in FIG. 2A may rotate the forward vector of the hologram to a degree of rotation to point toward the coordinates of the active speaker.

An example of a hologram that can be viewed from the rotation angle 1204 is a holographic meeting participant that has been scanned (or drawn in the case of animated avatars) in 360 degrees. However, some holographic meeting participants may only have avatars that are viewable from limited angles.

When the holographic meeting participant cannot be rendered to be viewed from the rotation angle, according to some examples, the method includes rotating the holographic meeting participant towards the active speaker at a maximum angle that can be rendered at block 1112. For example, the conference endpoint 202 illustrated in FIG. 2A may rotate the holographic meeting participant towards the active speaker at a maximum angle that can be rendered. It should be noted that this rotation is from the perspective of a non-speaking meeting participant. The hologram of the holographic meeting participant can be rotated to face the active speaker as perceived by the active speaker since there is no angle of rotation needed when the hologram is facing forward. But, for non-speaking meeting participants who will need to view the hologram from an angle, the hologram can appear to rotate by only as much as can be rendered. Therefore, to non-speaking meeting participants, it may appear as if the hologram has mostly rotated toward the active speaker but not all the way.

The methods FIG. 10 and FIG. 11 can be repeated for each holographic meeting participant. Also, a non-speaker in the context of FIG. 11 can also be a holographic meeting participant.

While the present technology has been addressed in the context of a mixed reality experience, may of the concepts addressed herein are also applicable in virtual reality. In virtual reality, it can also be disorienting to physically be in a room with another meeting participant and then to have that participant rendered in a different location. Accordingly, the present technology can be adapted to locate meeting participants in virtual environments in a way that maintains consistent placement of meeting participants and that can apply a relative orientation of meeting participants in a physical space in the virtual meeting room.

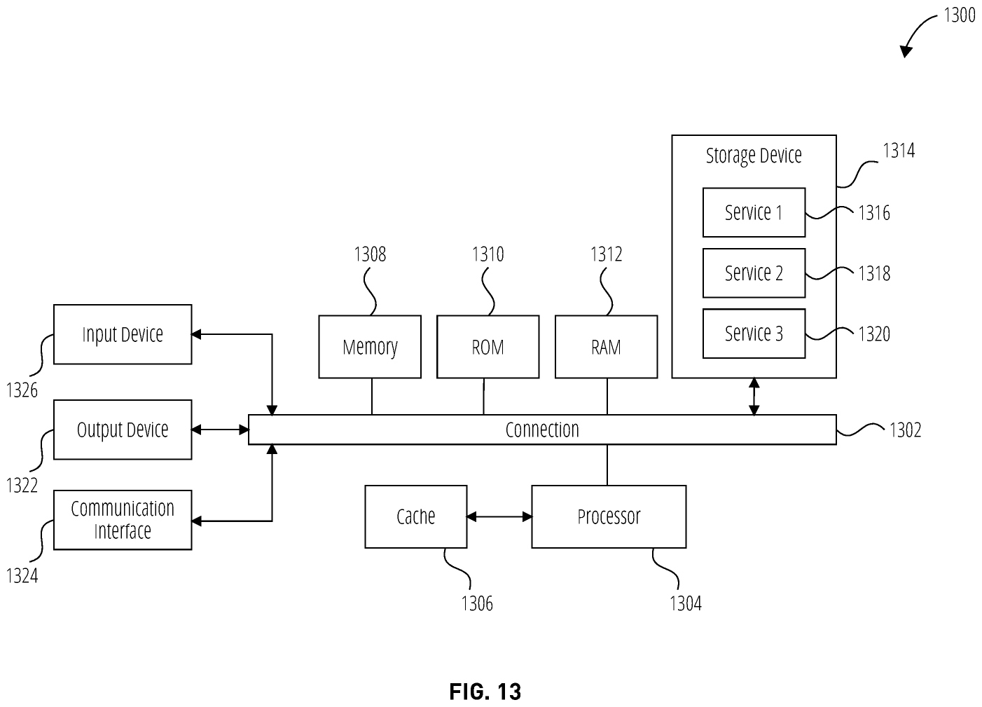

FIG. 13 shows an example of computing system 1300, which can be for example any computing device making up conference endpoint 202, conference service 204, mixed reality device 210, or any component thereof in which the components of the system are in communication with each other using connection 1302. Connection 1302 can be a physical connection via a bus, or a direct connection into processor 1304, such as in a chipset architecture. Connection 1302 can also be a virtual connection, networked connection, or logical connection.

In some embodiments, computing system 1300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1300 includes at least one processing unit (CPU or processor) 1304 and connection 1302 that couples various system components including system memory 1308, such as read-only memory (ROM) 1310 and random access memory (RAM) 1312 to processor 1304. Computing system 1300 can include a cache of high-speed memory 1306 connected directly with, in close proximity to, or integrated as part of processor 1304.

Processor 1304 can include any general purpose processor and a hardware service or software service, such as services 1316, 1318, and 1320 stored in storage device 1314, configured to control processor 1304 as well as a special-purpose processor where software instructions are incorporated into the actual processor design. Processor 1304 may essentially be a completely self-contained computing system, containing multiple cores or processors, a bus, memory controller, cache, etc. A multi-core processor may be symmetric or asymmetric.

To enable user interaction, computing system 1300 includes an input device 1326, which can represent any number of input mechanisms, such as a microphone for speech, a touch-sensitive screen for gesture or graphical input, keyboard, mouse, motion input, speech, etc. Computing system 1300 can also include output device 1322, which can be one or more of a number of output mechanisms known to those of skill in the art. In some instances, multimodal systems can enable a user to provide multiple types of input/output to communicate with computing system 1300. Computing system 1300 can include communication interface 1324, which can generally govern and manage the user input and system output. There is no restriction on operating on any particular hardware arrangement, and therefore the basic features here may easily be substituted for improved hardware or firmware arrangements as they are developed.

Storage device 1314 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1314 can include software services, servers, services, etc., that when the code that defines such software is executed by the processor 1304, it causes the system to perform a function. In some embodiments, a hardware service that performs a particular function can include the software component stored in a computer-readable medium in connection with the necessary hardware components, such as processor 1304, connection 1302, output device 1322, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### ASPECTS

The present technology includes computer-readable storage mediums for storing instructions, and systems for executing any one of the methods embodied in the instructions addressed in the aspects of the present technology presented below:

Aspect 1: A method for improved hologram location and hologram behavior in meetings, the method comprising: hosting, by a conference endpoint, a conference among at least three meeting participants that includes a first physically present meeting participant and a second physically present meeting participant that are bodily present in the physical meeting room, and holographic meeting participant that appears as a hologram in the physical meeting room; determining, by the conference endpoint, a first location of the first physically present meeting participant and a second location of the second physically present meeting participant in the physical meeting room; locating, by the conference endpoint, the holographic meeting participant in an available position that is not occupied by another of the at least three meeting participants, wherein the at least three meeting participants are located in different available positions in the physical meeting room, causing, by the conference endpoint, the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room, wherein the mixed reality devices are devices that display aspects of a physical environment such as the physical meeting room and display virtual aspects in the physical environment such as the holographic meeting participant located in the physical meeting room, wherein an augmented reality (AR) device, such as AR glasses, is an example of the mixed reality device.

Aspect 2. The method of Aspect 1, wherein the causing the holographic meeting participant to be rendered by mixed reality devices of the first physically present meeting participant and the second physically present meeting participant is affected through a direct communication link between the mixed reality devices present in the physical meeting room and the conference endpoint, or through a networked connection between the mixed reality devices and a meeting service, wherein the conference endpoint communicates information about the physical meeting room and positions occupied by the physically present meeting participants in the physical meeting room to enable the meeting service to make decisions to locate the holographic meeting participant in an available position.

Aspect 3. The method of any one of Aspects 1-2, further comprising: determining designated positions in the physical meeting room through human-aided configuration, the determining the available positions including: detecting an input from a human sitting in one of the designated positions, wherein the input causes the conference endpoint to register the human at a location in space within the physical meeting room, wherein the location in space is one of the designated positions, wherein the input can be verbal, a gesture recognized through a machine vision technique, or a section of a physical or software button that indicates the designated position within the physical meeting room.

Aspect 4. The method of any one of Aspects 1-3, further comprising: automatically determining designated positions in the physical meeting room, the automatically determining the designated positions including: detecting positions of human conference participants in the physical meeting room through the use of audio arrays, computer vision, or a combination of both over the course of one or more meetings taking place in the physical meeting room; identifying regularly occupied locations in the physical meeting room; registering the regularly occupied locations in the physical meeting room as the designated positions.

Aspect 5. The method of any one of Aspects 1-4, wherein the determining the first location of the first physically present meeting participant and the second location of the second physically present meeting participant in the physical meeting room further comprises: using microphone array to determine an angle and distance from a camera to a physically present meeting participant that is speaking; and/or using a camera with machine vision techniques and a directional microphone to determine the angle and distance from the camera to the physically present meeting participant that is speaking.

Aspect 6. The method of any one of Aspects 1-5, wherein the determining the first location of the first physically present meeting participant and the second location of the second physically present meeting participant in the physical meeting room further comprises: assigning the first physically present meeting participant to a first designated position that is closest to the first location of the first physically present meeting participant; and assigning the second physically present meeting participant to a second designated position that is closest to the second location of the second physically present meeting participant and that is not occupied by the first physically present meeting participant.

Aspect 7. The method of any one of Aspects 1-6, wherein the locating the holographic meeting participant in an available position comprises: identifying any unoccupied designated positions as available positions; ranking the available positions for suitability for rending of the holographic meeting participant, wherein factors that affect the suitability for rendering of the holographic meeting participant in one of the available positions includes an amount of free space around a respective available position, whether the holographic meeting participant can be clearly viewed by physically present meeting participants when taking into account angles from which the holographic meeting participant can be rendered, and lines of sight to the respective available position from the physically present meeting participants, etc.; and assigning the holographic meeting participant to a highly ranked available position.

Aspect 8. The method of any one of Aspects 1-7, wherein there are multiple holographic meeting participants, the method comprising: assigning the multiple holographic meeting participants to highly ranked available positions in a loop until all suitable available positions are occupied by a holographic meeting participant or a physically present meeting participant.

Aspect 9. The method of any one of Aspects 1-8, further comprising: determining that there are not enough available positions to accommodate at least one of the multiple holographic meeting participants; rotating the rendered holographic meeting participant at one of the designated positions occupied by a holographic meeting participant to render a holographic meeting participant that is an active speaker, or periodically, wherein the rendered holographic meeting participant at the designated position is the same for the first physically present meeting participant and the second physically present meeting participant.

Aspect 10. The method of any one of Aspects 1-9, further comprising: determining an active speaker from among the at least three meeting participants; determining that the holographic meeting participant is not the active speaker; causing the holographic meeting participant to face the active speaker when rendered by mixed reality devices of the first physically present meeting participant and the second physically present meeting participant, wherein the holograms that are not speaking are rotated towards the hologram or physical participant that is speaking.

Aspect 11. The method of any one of Aspects 1-10, further comprising: maintaining a map of the physical meeting room with x and y coordinates for the locations of the at least three meeting participants in the physical meeting room; rotating a forward vector of the holographic meeting participant a degree of rotation to point towards x and y coordinates of the active speaker.

Aspect 12. The method of any one of Aspects 1-11, further comprising: prior to causing the holographic meeting participant to rotate to point towards the coordinates of the active speaker, calculating the degree of rotation for the forward vector of the holographic meeting participant to point towards the active speaker; determining, for the holographic meeting participant, an angle spanning from the active speaker to another non-speaking one of the at least three meeting participants; determining that the holographic meeting participant can be rendered to be viewed from the angle by the non-speaking one of the at least three meeting participants.

Aspect 13. The method of any one of Aspects 1-12, further comprising: determining an active speaker from among the at least three meeting participants; determining that the holographic meeting participant is the active speaker; applying an active speaker behavior algorithm to control a direction of a forward vector of the holographic meeting participant, wherein the active speaker behavior algorithm causes the holographic meeting participant that is speaker to initially face an immediately previous active speaker and after a period begin to rotate towards other holographic meeting participants.

Aspect 14. The method of any one of Aspects 1-13, wherein the determination of the active speaker comprises: determining the holographic meeting participant is speaking when an audio level coming from a remote site associated with the holographic meeting participant is above a threshold; determining one of the first physically present meeting participant or the second physically present meeting participant is speaking when the microphone array (located in or connected to the video collaboration device) estimates the angle and the distance seen from the camera, if this corresponds to an estimated distance and angle for a machine learning module for head detection, the first physically present meeting participant or the second physically present meeting participant is speaking.

What is claimed is:

1. A method comprising:
hosting, by a conference endpoint, a conference among at least three meeting participants that includes a first physically present meeting participant and a second physically present meeting participant, and holographic meeting participant that appears as a hologram in a physical meeting room;
determining, by the conference endpoint, a first location of the first physically present meeting participant and a second location of the second physically present meeting participant in the physical meeting room;
locating, by the conference endpoint, the holographic meeting participant in an available position that is not occupied by another of the at least three meeting participants;
causing, by the conference endpoint, the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room.

2. The method of claim 1, wherein the causing the holographic meeting participant to be rendered by the mixed reality devices of the first physically present meeting participant and the second physically present meeting participant is affected through a direct communication link between the mixed reality devices present in the physical meeting room and the conference endpoint, or through a networked connection between the mixed reality devices and a meeting service, wherein the conference endpoint communicates information about the physical meeting room and positions occupied by the physically present meeting participants in the physical meeting room to enable the meeting service to make decisions to locate the holographic meeting participant in an available position.

3. The method of claim 1, wherein the determining the first location of the first physically present meeting participant and the second location of the second physically present meeting participant in the physical meeting room further comprises:
assigning the first physically present meeting participant to a first designated position that is closest to the first location of the first physically present meeting participant; and
assigning the second physically present meeting participant to a second designated position that is closest to the second location of the second physically present meeting participant and that is not occupied by the first physically present meeting participant.

4. The method of claim 1, wherein the locating the holographic meeting participant in an available position comprises:
identifying any unoccupied designated positions as available positions;
ranking the available positions for suitability for rending of the holographic meeting participant; and
assigning the holographic meeting participant to a highly ranked available position.

5. The method of claim 1, further comprising:
determining an active speaker from among the at least three meeting participants;
determining that the holographic meeting participant is not the active speaker;
causing the holographic meeting participant to face the active speaker when rendered by the mixed reality devices of the first physically present meeting participant and the second physically present meeting participant.

6. The method of claim 5, further comprising:
maintaining a map of the physical meeting room with x and y coordinates for the locations of the at least three meeting participants in the physical meeting room;
rotating a forward vector of the holographic meeting participant a degree of rotation to point towards coordinates of the active speaker.

7. The method of claim 6, further comprising:
prior to causing the holographic meeting participant to rotate to point towards the coordinates of the active speaker, calculating the degree of rotation for the forward vector of the holographic meeting participant to point towards the active speaker;
determining, for the holographic meeting participant, an angle spanning from the active speaker to another non-speaking one of the at least three meeting participants;
determining that the holographic meeting participant can be rendered to be viewed from the angle by the non-speaking one of the at least three meeting participants, and then causing the holographic meeting participant to be rendered at the angle of rotation;
determining that the holographic meeting participant cannot be rendered at the angle of rotation, and then rotating the holographic meeting participant towards the active speaker with at a maximum angle that can be rendered.

8. The method of claim 1, further comprising:
determining an active speaker from among the at least three meeting participants;
determining that the holographic meeting participant is the active speaker;
applying an active speaker behavior algorithm to control a direction of a forward vector of the holographic meeting participant, wherein the active speaker behavior algorithm causes the holographic meeting participant that is speaker to initially face an immediately previous active speaker and after a period begin to rotate towards other holographic meeting participants.

9. A computing system comprising:
at least one processor; and
a memory storing instructions that, when executed by the at least one processor, configure the computing system to:
host a conference among at least three meeting participants that includes a first physically present meeting participant and a second physically present meeting participant, and holographic meeting participant that appears as a hologram in a physical meeting room;
determine a first location of the first physically present meeting participant and a second location of the second physically present meeting participant in the physical meeting room;
locate the holographic meeting participant in an available position that is not occupied by another of the at least three meeting participants;
cause the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room.

10. The computing system of claim 9, wherein the determining the first location of the first physically present meeting participant and the second location of the second physically present meeting participant in the physical meeting room further comprises:
assign the first physically present meeting participant to a first designated position that is closest to the first location of the first physically present meeting participant; and
assign the second physically present meeting participant to a second designated position that is closest to the second location of the second physically present meeting participant and that is not occupied by the first physically present meeting participant.

11. The computing system of claim 9, wherein the locating the holographic meeting participant in an available position comprises:
identify any unoccupied designated positions as available positions;
rank the available positions for suitability for rending of the holographic meeting participant; and
assign the holographic meeting participant to a highly ranked available position.

12. The computing system of claim 9, wherein the computing system is further configured to:
determine an active speaker from among the at least three meeting participants;
determine that the holographic meeting participant is not the active speaker;
causing the holographic meeting participant to face the active speaker when rendered by the mixed reality devices of the first physically present meeting participant and the second physically present meeting participant.

13. The computing system of claim 12, wherein the computing system is further configured to:
maintain a map of the physical meeting room with x and y coordinates for the locations of the at least three meeting participants in the physical meeting room;
rotate a forward vector of the holographic meeting participant a degree of rotation to point towards coordinates of the active speaker.

14. The computing system of claim 13, wherein the computing system is further configured to:
prior to causing the holographic meeting participant to rotate to point towards the coordinates of the active speaker, calculate the degree of rotation for the forward vector of the holographic meeting participant to point towards the active speaker;
determine, for the holographic meeting participant, an angle spanning from the active speaker to another non-speaking one of the at least three meeting participants;
determine that the holographic meeting participant can be rendered to be viewed from the angle by the non-speaking one of the at least three meeting participants, and then causing the holographic meeting participant to be rendered at the angle of rotation;
determine that the holographic meeting participant cannot be rendered at the angle of rotation, and then rotating the holographic meeting participant towards the active speaker with at a maximum angle that can be rendered.

15. The computing system of claim 9, wherein the computing system is further configured to:
determine an active speaker from among the at least three meeting participants;
determine that the holographic meeting participant is the active speaker;
apply an active speaker behavior algorithm to control a direction of a forward vector of the holographic meeting participant, wherein the active speaker behavior algorithm causes the holographic meeting participant that is speaker to initially face an immediately previous active speaker and after a period begin to rotate towards other holographic meeting participants.

16. A non-transitory computer-readable storage medium, the computer-readable storage medium including instructions that when executed by at least one processor, cause the at least one processor to:
host a conference among at least three meeting participants that includes a first physically present meeting participant and a second physically present meeting participant, and holographic meeting participant that appears as a hologram in a physical meeting room;
determine a first location of the first physically present meeting participant and a second location of the second physically present meeting participant in the physical meeting room;
locate the holographic meeting participant in an available position that is not occupied by another of the at least three meeting participants;
cause the holographic meeting participant to be rendered by mixed reality devices of the first physically present meeting participant and the second physically present meeting participant in a consistent location in the physical meeting room such that both the first physically present meeting participant and the second physically present meeting participant perceive the holographic meeting participant to be located at the same position within the physical meeting room.

17. The computer-readable storage medium of claim 16, wherein the causing the holographic meeting participant to be rendered by the mixed reality devices of the first physically present meeting participant and the second physically present meeting participant is affected through a direct communication link between the mixed reality devices present in the physical meeting room and a conference endpoint, or through a networked connection between the mixed reality devices and a meeting service, wherein the conference endpoint communicates information about the physical meeting room and positions occupied by the physically present meeting participants in the physical meeting room to enable the meeting service to make decisions to locate the holographic meeting participant in an available position.

18. The computer-readable storage medium of claim 16, wherein the determining the first location of the first physically present meeting participant and the second location of the second physically present meeting participant in the physical meeting room further comprises:
assign the first physically present meeting participant to a first designated position that is closest to the first location of the first physically present meeting participant; and
assign the second physically present meeting participant to a second designated position that is closest to the second location of the second physically present meeting participant and that is not occupied by the first physically present meeting participant.

19. The computer-readable storage medium of claim 16, wherein the locating the holographic meeting participant in an available position comprises:
identify any unoccupied designated positions as available positions;
rank the available positions for suitability for rending of the holographic meeting participant; and
assign the holographic meeting participant to a highly ranked available position.

20. The computer-readable storage medium of claim 16, wherein the instructions cause the at least one processor to:
determine an active speaker from among the at least three meeting participants;
determine that the holographic meeting participant is not the active speaker;
causing the holographic meeting participant to face the active speaker when rendered by the mixed reality devices of the first physically present meeting participant and the second physically present meeting participant.
